(19) United States
(12) Patent Application Publication
(10) Pub. No.: US 2016/0086737 A1
(43) Pub. Date: Mar. 24, 2016

(54) ELECTRODE FOR DYE-SENSITIZED SOLAR CELL AND MANUFACTURING METHOD THEREFOR

(71) Applicant: KOREA ATOMIC ENERGY RESEARCH INSTITUTE, Daejeon (KR)

(72) Inventors: Hwa Jung KIM, Daejeon (KR); Hae Jun PARK, Jeongeup-si (KR); Ju Woon LEE, Jeongeup-si (KR)

(21) Appl. No.: 14/889,414

(22) PCT Filed: Apr. 23, 2014
(86) PCT No.: PCT/KR2014/003511

§ 371 Date: Nov. 5, 2015

(30) Foreign Application Priority Data
May 8, 2013 (KR) 10-2013-0051912

(51) Int. Cl. H01G 9/20; H01G 9/00

(52) U.S. Cl. CPC H01G 9/2022; H01G 9/0029

(57) ABSTRACT

An electrode for a dye-sensitized solar cell of the present invention includes a substrate; and a nanocomposite layer including a nanocomposite formed on the substrate, wherein the nanocomposite contains: metal, metal oxide or both; and inorganic materials, a conductive polymer or both.

### TECHNICAL FIELD

The present invention relates to an electrode for a dye-sensitized solar cell and a method of manufacturing the same.

### BACKGROUND ART

A dye-sensitized solar cell (DSSC), which simulates a plant obtaining energy through photosynthesis, relates to technology for generating electricity by applying a dye designed to suitably absorb sunlight onto an electrode material and placing a special dye between thin glass plates to absorb light. Due to the growth of a market of building-integrated photovoltaics (BIPV), a demand for DSSCs in such a technology is expected to increase exponentially around the year 2020.

However, DSSCs, which have been emerged as a next-generation solar cell, require a process of sintering titanium dioxide (TiO₂) nanoparticles, which are a core element for the DSSCs, at a temperature of 450° C. and require great costs and great amount of time when using a glass or metal substrate. In addition, using such substrates may have an issue in terms of flexibility and transparency. Further, for practical applications of the DSSCs to external environments, reducing costs, achieving flexibility, and enhancing durability may be necessary and a non-sintering process may also be necessary to solve such a bottleneck in the related industries.

### DISCLOSURE OF INVENTION

### Technical Goals

An aspect of the present invention provides an electrode for a dye-sensitized solar cell (DSSC) which is applicable to a flexible material such as plastic, glass, and film by emitting radiation instead of performing an existing sintering process at a high temperature.

Another aspect of the present invention provides a method of manufacturing an electrode for a DSSC, through which production and process time may be reduced.

Still another aspect of the present invention provides a DSSC having a durability and efficiency enhanced by preventing desorption of a dye.

### Technical Solutions

According to an aspect of the present invention, there is provided an electrode for a dye-sensitized solar cell (DSSC), the electrode including a substrate and a nanocomposite layer including a nanocomposite formed on the substrate. The nanocomposite may include a metal, a metal oxide, or both; and an inorganic material, a conductive polymer, or both.

The nanocomposite may be in a core-shell structure including a core and a shell covering the core. The core may include a metal, a metal oxide, or both, and the shell may include an inorganic material, a conductive polymer, or both. Alternatively, the core may include an inorganic material, a conductive polymer, or both, and the shell may include a metal, a metal oxide, or both.

The substrate may be at least one selected from the group consisting of glass, plastic, and a metal.

A thickness of the nanocomposite layer may be 1 nanometer (nm) to 10 micrometers (μm).

The metal may be at least one selected from the group consisting of titanium (Ti), zirconium (Zr), strontium (Sr), zinc (Zn), indium (In), iridium (Yr), lanthanum (La), vanadium (V), molybdenum (Mo), tungsten (W), tin (Sn), niobium (Nb), magnesium (Mg), aluminum (Al), yttrium (Y), scandium (Sc), samarium (Sm), and gallium (Ga), and the metal oxide may be at least one metal oxide selected from the group consisting of Ti, Zr, Sr, Zn, In, Yr, La, V, Mo, W, Sn, Nb, Mg, Al, Y, Sc, Sm, and Ga.

The metal oxide may include at least one selected from the group consisting of titanium dioxide (TiO₂), zinc oxide (ZnO), tin oxide (SnO₂), zirconium oxide (ZrO₂), niobium oxide (NbO), and strontium oxide (SrO).

The inorganic material may be a silicon (Si)-containing material.

The conductive polymer includes at least one polymer selected from the group consisting of polyaniline (PANI), polythiophene (PT), polypyrrole (PPy), polyindole (PIN), polyacetylene (PAc), polyphenylene sulfide (PPS), polyphenylene vinylene (PPV), polypyrene (PPr), polycarbazole (PCz), polyazulene (PAz), polyazepine (PAze), polyfluorene (PFO), polynaphthalene (PN), polyethylenedioxythiophene (PEDOT), derivatives thereof, and copolymers thereof.

The core may have a particle diameter of 1 nm to 100 nm.

A thickness of the shell may be 1 nm to 100 nm.

The nanocomposite may have a particle diameter of 2 nm to 200 nm.

The nanocomposite may be arranged in the nanocomposite layer in a vertical direction from the substrate.

The inorganic material and the conductive polymer may be chemically bonded to at least a portion thereof in response to radical polymerization occurring through radiation emission.

The nanocomposite layer and the substrate may be chemically bonded to at least a portion thereof in response to radical polymerization occurring through radiation emission.

The core and the shell may be chemically bonded to at least a portion thereof in response to radical polymerization occurring through radiation emission.

The shell may include a first shell formed on a surface of the core and including the conductive polymer and a second shell formed on an outer surface of the first shell and including the inorganic material. Alternatively, the shell may include a first shell formed on a surface of the core and including the inorganic material and a second shell formed on an outer surface of the first shell and including the conductive polymer. Alternatively, the shell may include a first shell formed on a surface of the core and including the metal and a second shell formed on an outer surface of the first shell and including the metal oxide. Alternatively, the shell may include a first shell formed on a surface of the core and including the metal oxide and a second shell formed on an outer surface of the first shell and including the metal.

According to another aspect of the present invention, there is provided a method of manufacturing an electrode for a DSSC, the method including applying, onto a substrate, a reactant solution including a metal precursor compound, a conductive monomer, and an inorganic material precursor, and forming a nanocomposite layer by emitting radiation to the reactant solution.

The radiation may include at least one selected from the group consisting of a gamma ray, an electron beam, an ion beam, and an x-ray.

The conductive monomer may include at least one selected from the group consisting of aniline, thiophene, pyrrole, indole, acetylene, phenylene sulfide, phenylene vinylene, pyrene, carbazole, azulene, azepine, fluorene, naphthalene, ethylenedioxythiophene, and derivatives thereof.

The reactant solution may include 0.1 to 10 parts by weight of a metal or metal oxide precursor, 0.1 to 10 parts by weight of the conductive monomer, and 0.1 to 10 parts by weight of an inorganic salt, based on 100 parts by weight of a solvent.

An amount of the radiation emission may be 1 to 500 kilograys (kGy).

The method may further include frothing the reactant solution by injecting a gas to the substrate onto which the reactant solution is applied.

The gas may be at least one selected from the group consisting of nitrogen (N₂), argon (Ar), neon (Ne), helium (He), and krypton (Kr).

The manufacturing of the electrode for a DSSC may be performed at an ordinary temperature or at less than or equal to 70° C.

Subsequent to the forming of the nanocomposite layer, the method may further include applying a dye onto a surface of the nanocomposite layer and drying the surface of the nanocomposite layer onto which the dye is applied.

Subsequent to the forming of the nanocomposite layer, the method may further include arranging the nanocomposite in the nanocomposite layer in a vertical direction from the substrate.

According to still another aspect of the present invention, there is provided a DSSC including an electrode for the DSSC, a counter electrode facing the electrode, and an electrolyte positioned between the two electrodes.

### Advantageous Effects of Invention

According to example embodiments, an electrode for a dye-sensitized solar cell (DSSC) may be immediately applied to a flexible material such as plastic, glass, and film by emitting radiation instead of performing an existing sintering process at a high temperature, and may contribute to price competitiveness and energy conservation due to a reduced production process and a reduced processing time.

In addition, for use in an external environment, desorption of the electrode and a dye may be prevented, and durability and efficiency may be enhanced, and thus the electrode may be widely used as a source material in nanoprinting and biological and electronic engineering fields in the future.

### BRIEF DESCRIPTION OF DRAWINGS

FIG. 1 is a diagram illustrating a method of manufacturing an electrode for a dye-sensitized solar cell (DSSC) according to an embodiment of the present invention.

FIG. 2 is a field emission scanning electron microscopy (FESEM) image of a supernatant and precipitate particles according to an embodiment of the present invention.

FIG. 3A is an FESEM image of an organic and inorganic titanium dioxide (TiO₂) composite, which is a composite including a silica, a conductive polymer, and TiO₂, according to an embodiment of the present invention.

FIG. 3B is an FESEM image of an organic and inorganic TiO₂ composite, which is a composite including a silica, a conductive polymer, and TiO₂, according to an embodiment of the present invention.

FIG. 4A is an FESEM image of a supernatant of an organic and inorganic TiO₂ composite, which is a composite including a conductive polymer and TiO₂, according to an embodiment of the present invention.

FIG. 4B is an FESEM image of precipitate particles obtained from a supernatant, of an organic and inorganic TiO₂ composite, which is a composite including a conductive polymer and TiO₂, according to an embodiment of the present invention.

FIG. 5A is an FESEM image of an indium tin oxide (ITO) substrate of an organic and inorganic TiO₂ composite, which is a composite including a conductive polymer and TiO₂, according to an embodiment of the present invention.

FIG. 5B is an FESEM image of an ITO substrate coated with a dye, of an organic and inorganic TiO₂ composite, which is a composite including a conductive polymer and TiO₂, according to an embodiment of the present invention.

### BEST MODE FOR CARRYING OUT INVENTION

Reference will now be made in detail to example embodiments of the present invention, examples of which are illustrated in the accompanying drawings.

According to an embodiment of the present invention, an electrode for a dye-sensitized solar cell (DSSC) includes a substrate, and a nanocomposite layer including a nanocomposite formed on the substrate. The nanocomposite includes a metal, a metal oxide, or both; and an inorganic material, a conductive polymer, or both. Here, the substrate is at least one selected from the group consisting of glass, plastic, and metal. The electrode including the foregoing components may be manufactured without performing a sintering process at a high temperature, and thus may be applicable to a flexible material having a relatively low level of thermal resistance, for example, plastic, in addition to glass.

The nanocomposite is provided in a core-shell structure including a core and a shell covering the core. The core includes a metal, a metal oxide, or both, and the shell includes an inorganic material, a conductive polymer, or both. Alternatively, the core includes an inorganic material, a conductive polymer, or both, and the shell includes a metal, a metal oxide, or both. That is, the components included in the core and the shell may change vice versa.

A thickness of the nanocomposite layer including the nanocomposite may be 1 nanometer (nm) to 10 micrometers (μm), and desirably 1 nm to 5 μm, and more desirably 1 nm to 1 μm.

The metal may be at least one selected from the group consisting of titanium (Ti), zirconium (Zr), strontium (Sr), zinc (Zn), indium (In), iridium (Yr), lanthanum (La), vanadium (V), molybdenum (Mo), tungsten (W), tin (Sn), niobium (Nb), magnesium (Mg), aluminum (Al), yttrium (Y), scandium (Sc), samarium (Sm), and gallium (Ga), and the metal oxide may be an oxide thereof. The metal oxide may be desirably at least one selected from the group consisting of titanium dioxide (TiO₂), zinc oxide (ZnO), tin oxide (SnO₂), zirconium oxide (ZrO₂), niobium oxide (NbO), and strontium oxide (SrO), and more desirably the TiO₂.

The inorganic material, which is used to adjust conductivity, and stabilize and fix metallic nanoparticles, may be a material containing silicon (Si) such as silica and silicon, and desirably sodium metasilicate (Na₂SiO₃).

The conductive polymer may include at least one polymer selected from the group consisting of polyaniline (PANI), polythiophene (PT), polypyrrole (PPy), polyindole (PIN), polyacetylene (PAc), polyphenylene sulfide (PPS), polyphenylene vinylene (PPV), polypyrene (PPr), polycarbazole (PCz), polyazulene (PAz), polyazepine (PAze), polyfluorene (PFO), polynaphthalene (PN), polyethylenedioxythiophene (PEDOT), derivatives thereof, and copolymers thereof, and may desirably use the PANI.

The core may have a particle diameter of 1 nm to 100 nm, and a thickness of the shell may be 1 nm to 100 nm.

The particle diameter of 1 nm of the core and the shell, which corresponds to a length by which five hydrogen atoms are arranged in a line, is a minimum value for a physical arrangement. When the particle diameter exceeds 100 nm, efficiency of such a physical property may be reduced. A piratical diameter of the nanocomposite, which is a combination of the diameter of the core and the thickness of the shell, may be 2 nm to 200 nm.

The nanocomposite may be arranged in the nanocomposite layer in a vertical direction from the substrate. Due to the nanocomposite arranged on the substrate in the vertical direction, desorption of a dye may be reduced and thus, durability and efficiency of the electrode may be enhanced.

At least a portion of the inorganic material and the conductive polymer may be chemically bonded. At least a portion of the nanocomposite layer and the substrate may be chemically bonded. At least a portion of the core and the shell may be chemically bonded. Such a chemical bonding may occur when radical polymerization occurs among the inorganic material, the conductive polymer, and the metal oxide through radiation emission.

The shell may include a first shell formed on a surface of the core and including the conductive polymer and a second shell formed on an outer surface of the first shell and including the inorganic material, include a first shell formed on a surface of the core and including the inorganic material and a second shell formed on an outer surface of the first shell and including the conductive polymer, include a first shell formed on a surface of the core and including the metal and a second shell formed on an outer surface of the first shell and including the metal oxide, or include a first shell formed on a surface of the core and including the metal oxide and a second shell formed on an outer surface of the first shell and including the metal.

A method of manufacturing the electrode for a DSSC includes applying, onto the substrate, a reactant solution including a metal precursor compound, a conductive monomer, and an inorganic material precursor, and forming the nanocomposite layer by emitting radiation to the reactant solution.

The radiation may include at least one selected from the group consisting of a gamma ray, an electron beam, an ion beam, and an x-ray, and desirably use the gamma ray.

The conductive monomer may include at least one selected from the group consisting of aniline, thiophene, pyrrole, indole, acetylene, phenylene sulfide, phenylene vinylene, pyrene, carbazole, azulene, azepine, fluorene, naphthalene, ethylenedioxythiophene, derivatives thereof, and copolymers thereof, and desirably use the aniline.

The reactant solution may include 0.1 to 10 parts by weight of a metal or metal oxide precursor, 0.1 to 10 parts by weight of the conductive monomer, and 0.1 to 10 parts by weight of an inorganic salt, based on 100 parts by weight of a solvent.

An amount of the radiation emission may be 1 to 500 kilograys (kGy). When the amount of the radiation emission is less than 5 kGy, forming the nanocomposite in the core-shell structure may not be easily performed, and thus the amount of the radiation emission may be desirably 100 kGy, and more desirably 30 kGy.

The method of manufacturing the electrode may further include frothing the reactant solution by injecting a gas to the substrate onto which the reactant solution is applied. The frothing may be performed for approximately 5 to 30 minutes (min.) for workability and process efficiency, although the frothing may be sufficiently performed.

The gas may be at least one selected from the group consisting of nitrogen (N₂), argon (Ar), neon (Ne), helium (He), and krypton (Kr), and desirably use the nitrogen gas.

The manufacturing of the electrode for a DSSC may be performed at an ordinary temperature, or room temperature, or at a temperature less than or equal to 70° C. Thus, the manufactured electrode may be suitably applied to, for example, a plastic substrate which has a relatively low thermal resistance and thus may not be used as a substrate at a high temperature.

Subsequent to the formation of the nanocomposite layer, the method of manufacturing the electrode may further include applying a dye onto a surface of the nanocomposite layer and drying the surface of the nanocomposite layer onto which the dye is applied.

Subsequent to the formation of the nanocomposite layer, the method of manufacturing the electrode may further include arranging the nanocomposite in the nanocomposite layer in a vertical direction from the substrate. Thus, desorption of the electrode and the dye may be prevented. For such a vertical arrangement, a method of forming a magnetic field or performing a gravity-based arrangement may be applied.

A DSSC according to an embodiment includes an electrode for the DSSC, a counter electrode facing the electrode, and an electrolyte disposed between the two electrodes.

The electrode for the DSSC may be immediately applicable to a flexible material such as, for example, plastic and film, in addition to a glass substrate because pasting is enabled without mixing other pasting materials and sintering is performed, through emission of a gamma ray in lieu of an existing sintering process performed at a high temperature.

Hereinafter, the present invention will be described in more detail based on the following examples. However, the present invention may not be limited to the following examples.

### EXAMPLE

### Manufacturing an Electrode for a DSSC

Titanium isopropoxide, Na₂SiO₃, and aniline monomer were added, in due order, to ethanol and stirred. Such a reactant solution was left at a room temperature for approximately one and a half hours, and then a nitrogen gas was injected to the reactant solution to be frothed for approximately 30 min. The frothed reactant solution was applied onto a glass substrate and then a gamma ray was emitted. A total amount of the emission of the gamma ray was 30 kGy.

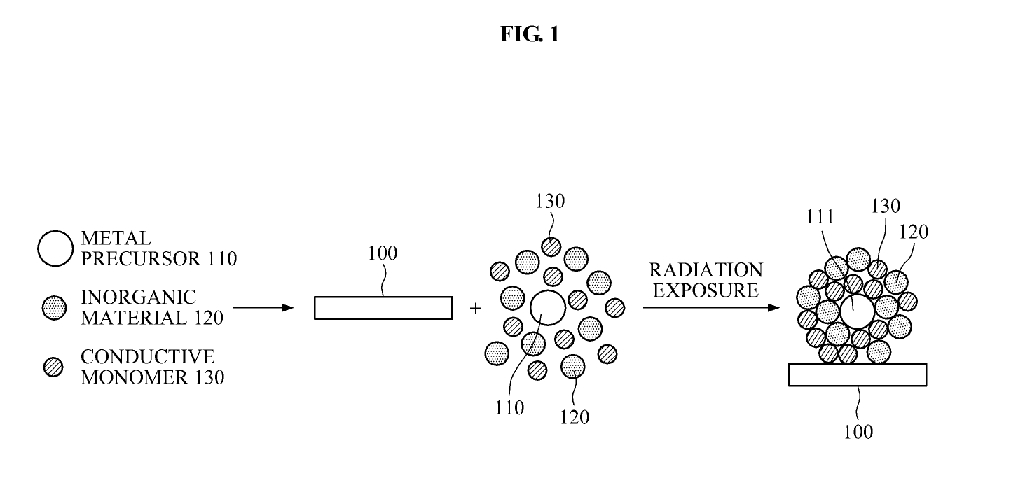

FIG. 1 is a diagram illustrating a method of manufacturing the electrode for a DSSC according to the foregoing example.

### Scanning Electron Microscopy (SEM)-Based Analysis of the Electrode for a DSSC

To verify a form of a nanocomposite which is a precipitate obtained from the foregoing example, a field emission SEM (FESEM) (SU-70, HITACHI, JAPAN) analysis was performed.

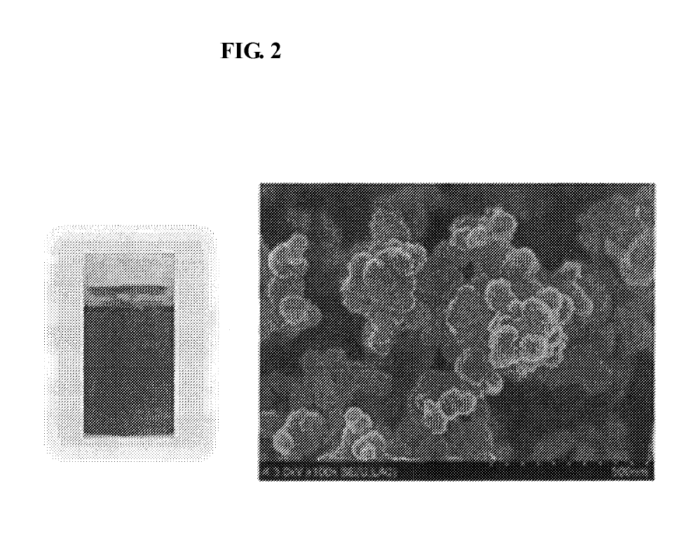

FIG. 2 is an FESEM image of supernatant and precipitate particles obtained therefrom according to the foregoing example. A novel TiO₂-PANI-silica or PANI-TiO₂-silica nanocomposite in a spherical form of a nanosize may be manufactured through concurrent radical polymerization occurring by emitting gamma rays to TiO2 precursors, conductive polymers which consist of aniline monomers, and silica which is an inorganic material. Thus, it was verified that the nanocomposite has a core-shell structure in which a surface of a core including TiO₂ nanoparticles is surrounded by a shell including the aniline monomers and the silica bonded together, and the nanocomposite is arranged and formed on the glass substrate in a vertical direction.

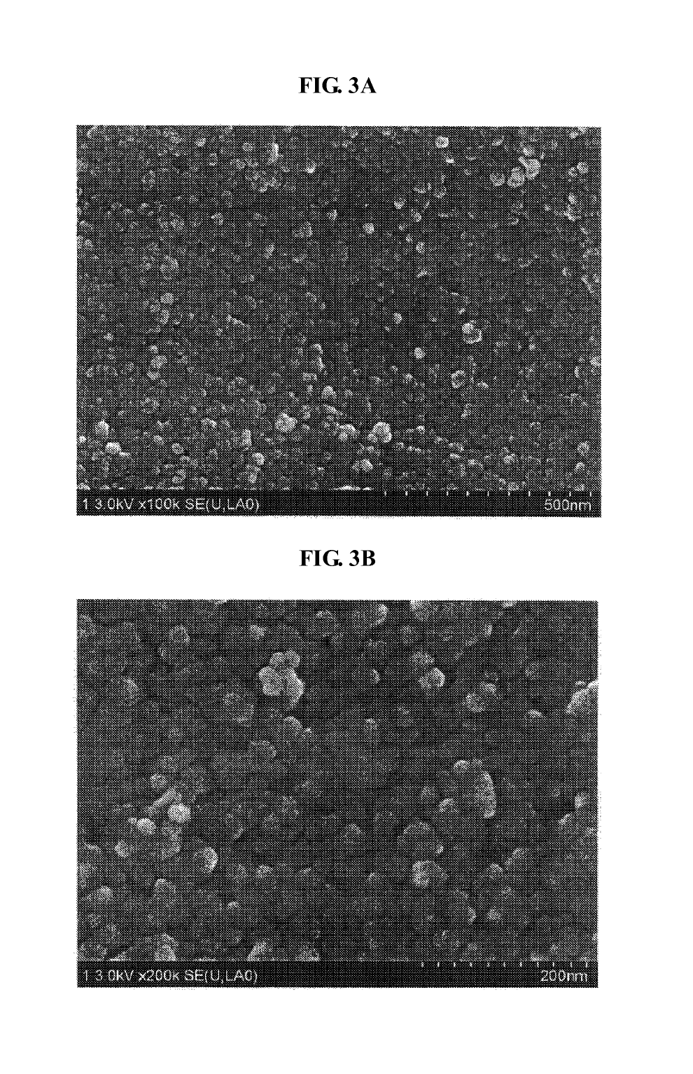

FIGS. 3A and 3B are FESEM images of an organic and inorganic TiO₂ composite, which is a composite including the silica, the conductive polymer, and the TiO₂, according to the foregoing example. Based on the images, it was verified that the composite is compounded with a solution which is clear and light orange brown, and is formed with approximately 10 nm to 50 nm-sized spherical particles.

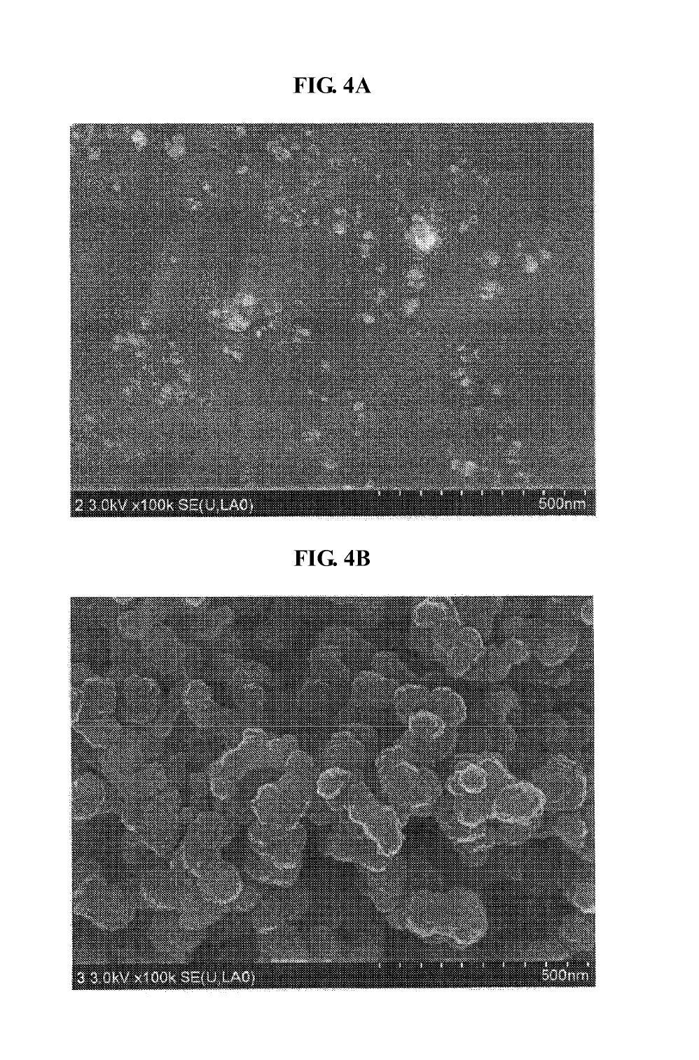

FIGS. 4A and 4B are FESEM images of an organic and inorganic TiO₂ composite, which is a composite including the conductive polymer and the TiO₂, for example, supernatant (refer to FIG. 4A) and precipitate particles obtained therefrom (refer to FIG. 4B), according to the foregoing example. The precipitate particles in FIG. 4B are particles obtained by evaporating moisture of the entire solution including the supernatant of the composite. Based on the images, it was verified that the organic and inorganic TiO₂ composite of FIGS. 4A and 4B is formed with spherical particles of a size of approximately 100 nm or less.

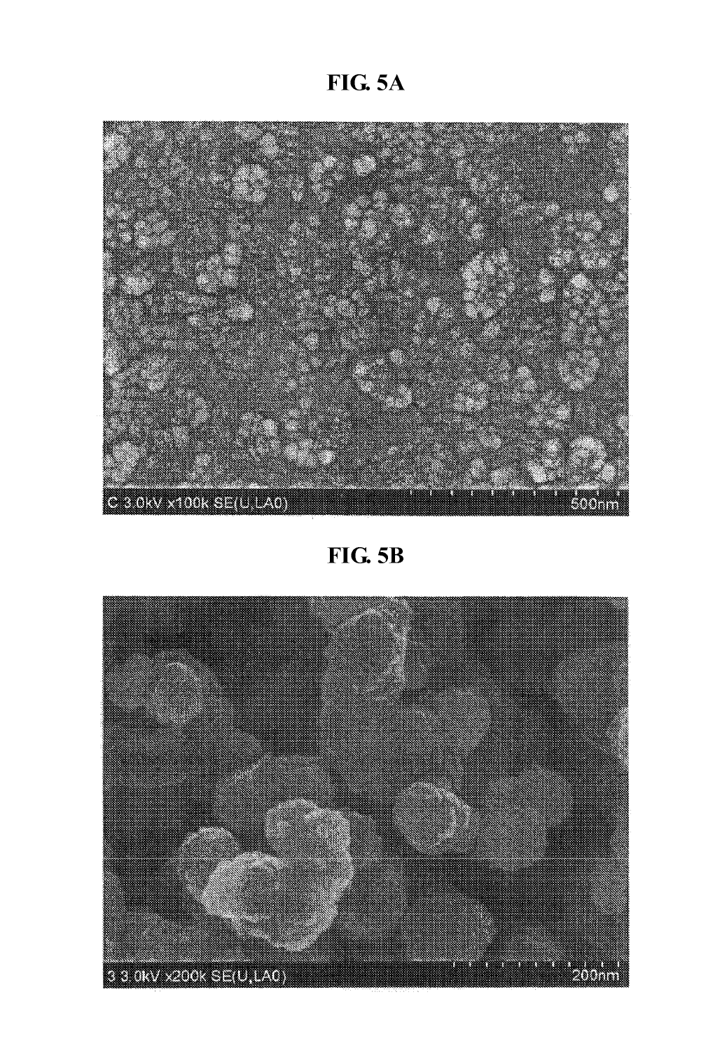

FIGS. 5A and 5B are FESEM images of an organic and inorganic TiO₂ composite, which is a composite including the conductive polymer and the TiO₂, for example, an indium tin oxide (ITO) substrate (refer to FIG. 5A) and an ITO substrate coated with a dye (refer to FIG. 5B), according to the foregoing example. Based on the images, it was verified that formation of the composite and the coating performed on the substrate are desirably performed.

1. An electrode for a dye-sensitized solar cell (DSSC), comprising:
a substrate; and
a nanocomposite layer comprising a nanocomposite formed on the substrate, and
wherein the nanocomposite comprises a metal, a metal oxide, or both; and an inorganic material, a conductive polymer, or both.

2. The electrode of claim 1, wherein the nanocomposite is in a core-shell structure comprising a core and a shell covering the core, and
wherein the core comprises a metal, a metal oxide, or both, and the shell comprises an inorganic material, a conductive polymer, or both, or
the core comprises an inorganic material, a conductive polymer, or both, and the shell comprises a metal, a metal oxide, or both.

3. The electrode of claim 1, wherein a thickness of the nanocomposite layer is 1 nanometer (nm) to 10 micrometers (μm).

4. The electrode of claim 1, wherein the metal is at least one selected from the group consisting of titanium (Ti), zirconium (Zr), strontium (Sr), zinc (Zn), indium (In), iridium (Yr), lanthanum (La), vanadium (V), molybdenum (Mo), tungsten (W), tin (Sn), niobium (Nb), magnesium (Mg), aluminum (Al), yttrium (Y), scandium (Sc), samarium (Sm), and gallium (Ga), and the metal oxide is at least one metal oxide selected from the group consisting of Ti, Zr, Sr, Zn, In, Yr, La, V, Mo, W, Sn, Nb, Mg, Al, Y, Sc, Sm, and Ga.

5. The electrode of claim 1, wherein the inorganic material is a silicon (Si)-containing material.

6. The electrode of claim 1, wherein the conductive polymer comprises at least one polymer selected from the group consisting of polyaniline (PANI), polythiophene (PT), polypyrrole (PPy), polyindole (PIN), polyacetylene (PAc), polyphenylene sulfide (PPS), polyphenylene vinylene (PPV), polypyrene (PPr), polycarbazole (PCz), polyazulene (PAz), polyazepine (PAze), polyfluorene (PFO), polynaphthalene (PN), polyethylenedioxythiophene (PEDOT), derivatives thereof, and copolymers thereof.

7. The electrode of claim 2, wherein the core has a particle diameter of 1 nm to 100 nm, and a thickness of the shell is 1 nm to 100 nm.

8. The electrode of claim 1, wherein the nanocomposite is arranged in the nanocomposite layer in a vertical direction from the substrate.

9. The electrode of claim 1, wherein the inorganic material and the conductive polymer are chemically bonded to at least a portion thereof in response to radical polymerization occurring through radiation emission.

10. The electrode of claim 1, wherein the nanocomposite layer and the substrate are chemically bonded to at least a portion thereof in response to radical polymerization occurring through radiation emission.

11. The electrode of claim 2, wherein the core and the shell are chemically bonded to at least a portion thereof in response to radical polymerization occurring through radiation emission.

12. The electrode of claim 2, wherein the shell comprises a first shell formed on a surface of the core and comprising the conductive polymer and a second shell formed on an outer surface of the first shell and comprising the inorganic material,
the shell comprises a first shell formed on a surface of the core and comprising the inorganic material and a second shell formed on an outer surface of the first shell and comprising the conductive polymer,
the shell comprises a first shell formed on a surface of the core and comprising the metal and a second shell formed on an outer surface of the first shell and comprising the metal oxide, or
the shell comprises a first shell formed on a surface of the core and comprising the metal oxide and a second shell formed on an outer surface of the first shell and comprising the metal.

13. A method of manufacturing an electrode for a dye-sensitized solar cell (DSSC), the method comprising:
applying, onto a substrate, a reactant solution comprising a metal precursor compound, a conductive monomer, and an inorganic material precursor; and
forming a nanocomposite layer by emitting radiation to the reactant solution.

14. The method of claim 13, wherein the conductive monomer comprises at least one selected from the group consisting of aniline, thiophene, pyrrole, indole, acetylene, phenylene sulfide, phenylene vinylene, pyrene, carbazole, azulene, azepine, fluorene, naphthalene, ethylenedioxythiophene, and derivatives thereof.

15. The method of claim 13, wherein the reactant solution comprises 0.1 to 10 parts by weight of a metal or a metal oxide precursor, 0.1 to 10 parts by weight of the conductive monomer, and 0.1 to 10 parts by weight of an inorganic salt, based on 100 parts by weight of a solvent.

16. The method of claim 13, wherein an amount of the radiation emission is 1 to 500 kilograys (kGy).

17. The method of claim 13, further comprising:
frothing the reactant solution by injecting a gas to the substrate onto which the reactant solution is applied, and
wherein the gas is at least one selected from the group consisting of nitrogen (N₂), argon (Ar), neon (Ne), helium (He), and krypton (Kr).

18. The method of claim 13, wherein the manufacturing of the electrode for a DSSC is performed at an ordinary temperature or at less than or equal to 70° C.

19. The method of claim 13, further comprising:
applying a dye onto a surface of the nanocomposite layer and drying the surface of the nanocomposite layer onto which the dye is applied, subsequent to the forming of the nanocomposite layer.

20. The method of claim 13, further comprising:
arranging the nanocomposite in the nanocomposite layer in a vertical direction from the substrate, subsequent to the forming of the nanocomposite layer.
